(19) United States
(12) Patent Application Publication
(10) Pub. No.: US 2016/0165207 A1
(43) Pub. Date: Jun. 9, 2016

(54) ELECTRONIC DEVICE, METHOD, AND COMPUTER PROGRAM PRODUCT

(71) Applicants: Kabushiki Kaisha Toshiba, Tokyo (JP); Toshiba Lifestyle Products & Services Corporation, Tokyo (JP)

(72) Inventors: Takahiro TAKIMOTO, Sayama Saitama (JP); Tatsuro FUJISAWA, Fuchu Tokyo (JP); Makoto OSHIKIRI, Akishima Tokyo (JP)

(21) Appl. No.: 14/874,827

(22) Filed: Oct. 5, 2015

Related U.S. Application Data
(60) Provisional application No. 62/087,100, filed on Dec. 3, 2014.

(51) Int. Cl. H04N 13/00; G06F 3/0484

(52) U.S. Cl. CPC H04N 13/0022; G06F 3/04847

(57) ABSTRACT

In general, according to one embodiment, an electronic device includes a hardware processor. The hardware processor is configure to outputs a user interface for designating disparity sharpness related to a difference in sharpness at a border between an object and a background of the object, the difference resulting from a difference in depth-direction distances of the object and the background, and to sets the sharpness at the border between the background and the object based on the disparity sharpness designated via the user interface, and to generates one multiscopic image from parallax images.

### CROSS-REFERENCE TO RELATED APPLICATION

This application claims the benefit of U.S. Provisional Patent Application No. 62/087,100, filed Dec. 3, 2014, the entire contents of which are incorporated herein by reference.

### FIELD

Embodiments described herein relate generally to an electronic device, a method, and a computer program product.

### BACKGROUND

Mounting of a stereoscopic display device, what is called a three-dimensional display (3D display), capable of displaying images three dimensionally on an electronic device such as a television (TV) has conventionally been practiced.

In a three-dimensional display, slits, a lenticular sheet (cylindrical lens array), or the like are used to achieve a binocular parallax (horizontal parallax). A three-dimensional display having such a structure provides a three-dimensional view by presenting an image for a right eye to the right eye of a user, and presenting an image for a left eye to the left eye of the user.

To provide a three-dimensional view of an image on a three-dimensional display, a predetermined parallax image generating process for giving a natural-looking three-dimensional effect to the image to be displayed needs to be applied to the image data representing the image to be displayed.

The predetermined parallax image generating process, however, has not always resulted in a natural-looking three-dimensional effect, for example, when images captured in real time are displayed three dimensionally.

Furthermore, there have been demands for operation environments allowing users to achieve a desirable three-dimensional effect depending on the conditions in which images are captured.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a block diagram of a general structure of a three-dimensional display system according to a first embodiment;

FIG. 2 is a block diagram of a general structure of an electronic device in the first embodiment;

FIG. 3 is a schematic view for explaining an example of a display screen on a display in the first embodiment;

FIG. 4 is an enlarged view of a generating operation screen in the first embodiment;

FIG. 5 is a flowchart of a process in the first embodiment;

FIG. 6A is a first schematic view for explaining a picture position changing process in the first embodiment;

FIG. 6B is a second schematic view for explaining the picture position changing process in the first embodiment;

FIG. 7A is a schematic view for explaining an example of parallax images in a stereo video in the first embodiment;

FIG. 7B is a schematic view for explaining an example of extraction of an object position in the first embodiment;

FIG. 7C is a schematic view for explaining a disparity sharpness changing process with a small amount of disparity sharpness adjustment, achieved by setting a disparity sharpness adjustment intensity to a low level in the first embodiment;

FIG. 7D is a schematic view for explaining the disparity sharpness changing process with a medium amount of disparity sharpness adjustment, achieved by setting the disparity sharpness adjustment intensity to a medium level in the first embodiment;

FIG. 7E is a schematic view for explaining the disparity sharpness changing process with a large amount of disparity sharpness adjustment, achieved by setting the disparity sharpness adjustment intensity to a high level in the first embodiment;

FIG. 8 is a schematic view for explaining a disparity stability adjustment process in the first embodiment;

FIG. 9A is a schematic view for explaining a disparity boundary adjustment process with a small amount of disparity boundary adjustment, achieved by setting a disparity boundary adjustment intensity to a low level in the first embodiment;

FIG. 9B is a schematic view for explaining the disparity boundary adjustment process with a medium amount of disparity boundary adjustment, achieved by setting the disparity boundary adjustment intensity to a medium level in the first embodiment; and

FIG. 9C is a schematic view for explaining the disparity boundary adjustment process with a large amount of disparity boundary adjustment, achieved by setting the disparity boundary adjustment intensity to a high level in the first embodiment.

### DETAILED DESCRIPTION

In general, according to an embodiment, an electronic device comprises a hardware processor. The hardware processor is configure to outputs a user interface for designating disparity sharpness related to a difference in sharpness at a border between an object and a background of the object, the difference resulting from a difference in depth-direction distances of the object and the background, and to sets the sharpness at the border between the background and the object based on the disparity sharpness designated via the user interface, and to generates one multiscopic image from parallax images.

Generally, according to an embodiment, when an electronic device generates one multiscopic image using a plurality of parallax images, an operation module in the electronic device can input a first operation for designating the degree of difference in disparity sharpness between an object and the background of the object, the difference resulting from the difference in the depth-direction distance between the object and the background of the object.

A processing module then sets the disparity sharpness at a border area between the background and the object based on the degree of difference in disparity sharpness designated by the input first operation.

The embodiment will now be explained in detail with reference to some drawings.

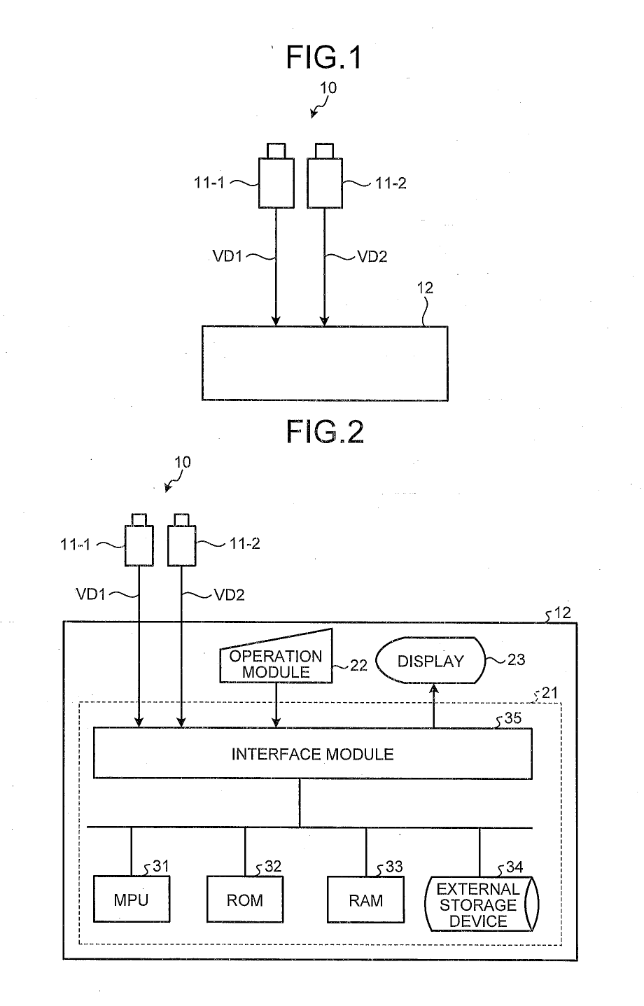

FIG. 1 is a block diagram of a general configuration of a three-dimensional display system according to the embodiment.

This three-dimensional display system 10 is a system for generating a three-dimensional image (video) based on the parallel viewing method, and comprises two video cameras 11-1 and 11-2 and an electronic device 12. The distance between the optical axes of the lenses of the respective video cameras 11-1 and 11-2 is fixed, and the video cameras 11-1 and 11-2 are adjusted so that their optical axes are oriented to the same direction. These video cameras 11-1 and 11-2 are provided to capture binocular parallax images. The electronic device 12 receives inputs of captured data VD1 and VD2 output from the video cameras 11-1 and 11-2, respectively, generates multiscopic image data by performing image processing on the data, and displays (or outputs) the multiscopic image data.

The process of generating the multiscopic image data is disclosed in detail in Japanese Patent Application Laid-open No. 2013-070267, for example, and the detailed explanation thereof is omitted herein.

FIG. 2 is a block diagram of a general configuration of the electronic device.

The electronic device 12 comprises a main processing apparatus 21, an operation module 22, and a display 23. The main processing apparatus 21 processes operations for generating the multiscopic image data based on the input captured data VD1 and VD2. The operation module 22 is configured as a keyboard, a mouse, or a tablet, for example, with which an operator performs various operations. The display 23 is capable of displaying a generating operation screen, which is to be described later, and the generated multiscopic image.

The main processing apparatus 21 is configured as what is called a microcomputer, and comprises a micro-processing unit (MPU) 31, a read-only memory (ROM) 32, a random access memory (RAM) 33, an external storage device 34, and an interface module 35. The MPU 31 controls the entire electronic device 12. The ROM 32 stores therein various pieces of data, including a computer program, non-volatilely. The RAM 33 stores therein various types of data temporarily, and is also used as a working area of the MPU 31. The external storage device 34 is provided as a hard disk drive (HDD) or a solid state drive (SSD), for example. The interface module 35 takes an interface with the video cameras 11-1 and 11-2, the display 23, the operation module 22, and the like.

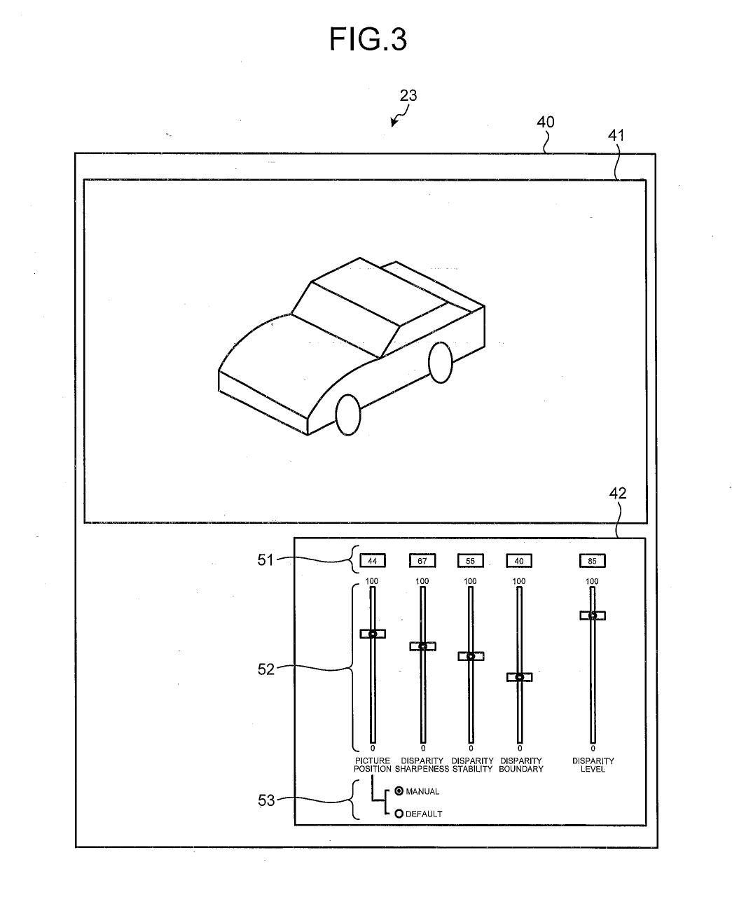

FIG. 3 is a schematic view for explaining an example of a display screen on the display.

This display screen 40 displayed on the display 23 has a three-dimensional image display area 41 for displaying a three-dimensional image resulting from processing operations for generating multiscopic image data, and a generating operation screen 42 serving as a graphical user interface (GUI) for making the operations for generating the multiscopic image data.

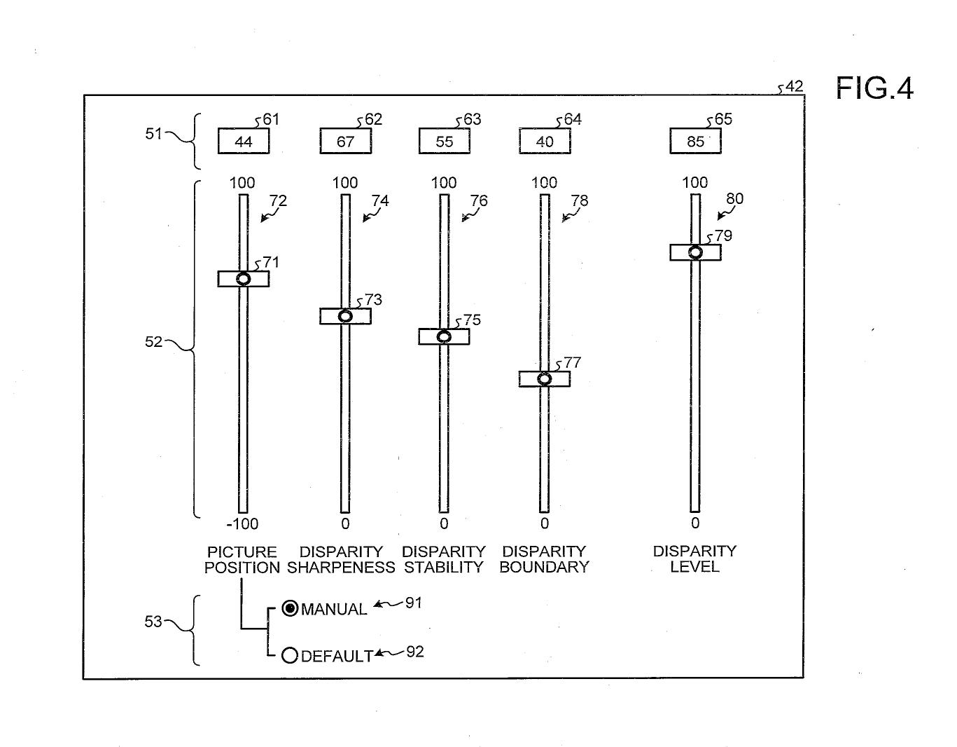

FIG. 4 is an enlarged view of the generating operation screen.

The generating operation screen 42 comprises a setting display area 51 for displaying settings resulting from the generating operations performed by a user (operator), an operation area 52 enabling users to perform the generating operations visually, and an operation mode setting area 53 for setting an operation mode.

The setting display area 51 comprises a picture position setting display box 61 for displaying a picture position setting, a disparity sharpness setting display box 62 for displaying a disparity sharpness setting, a disparity stability setting display box 63 for displaying a disparity stability adjustment setting, a disparity boundary setting display box 64 for displaying a disparity boundary adjustment setting, and a disparity level setting display box 65 for displaying a disparity level setting.

The operation area 52 comprises a picture position setting slider bar 72 including a slider (image) 71 for designating a picture position setting, a disparity sharpness setting slider bar 74 including a slider (image) 73 for designating a disparity sharpness setting, a disparity stability setting slider bar 76 including a slider (image) 75 for adjusting the disparity stability, a disparity boundary setting slider bar 78 including a slider (image) 77 for adjusting the disparity boundary, and a disparity level setting slider bar 80 including a slider (image) 79 for designating a disparity level.

The operation mode setting area 53 includes a manual operation mode radio button 91 and a default mode radio button 92 one of which is exclusively selected when a user clicks on the corresponding radio button. The manual operation mode radio button 91 is selected when the operation mode is a manual picture position operation mode in which a user can make the disparity adjustments manually. The default mode radio button 92 is selected when the operation mode is a picture position default mode in which the disparity adjustments are fixed to default values.

The operation according to the embodiment will now be explained.

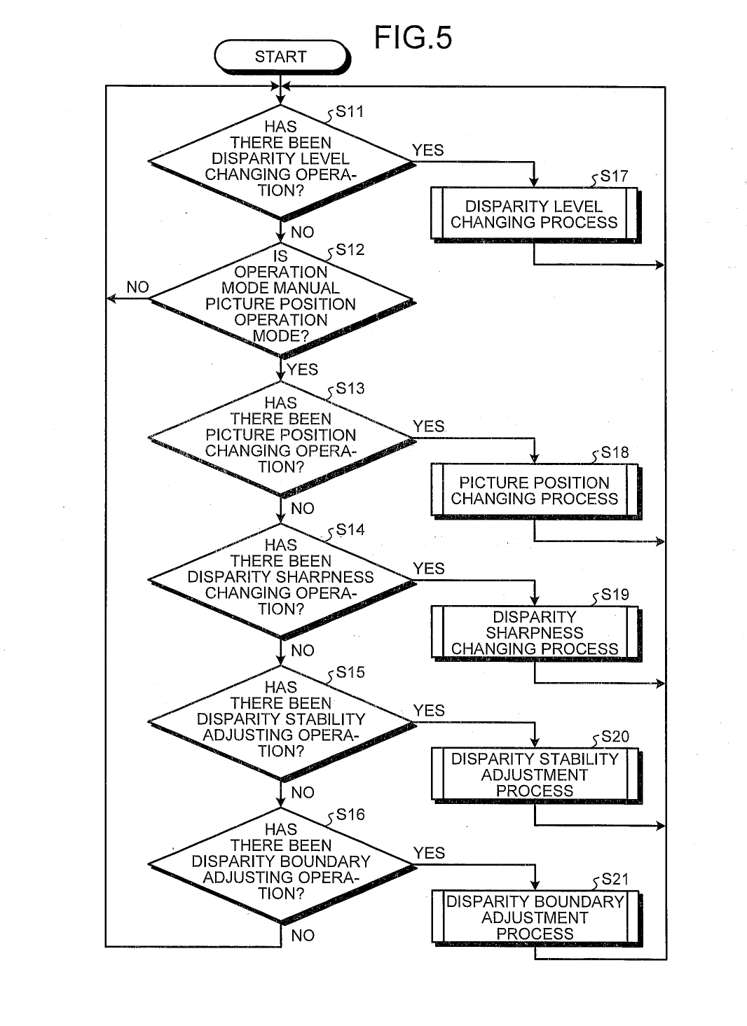

FIG. 5 is a flowchart of the process in the embodiment.

To begin with, the MPU 31 determines if a user has performed an operation of changing the disparity level, by changing the position of the slider (image) 79 for designating the disparity level on the disparity level setting slider bar 80 (S11).

In the determination at S11, if it is determined that a user has performed the operation of changing the disparity level by changing the position of the slider (image) 79 (Yes at S11), the MPU 31 performs a disparity level changing process (S17). In the disparity level changing process, if the specified value is larger than that before the changing operation, the MPU 31 controls to generate a multiscopic image with an increased parallax. If the specified value is smaller than that before the changing operation, the MPU 31 controls to generate a multiscopic image with a decreased parallax. The MPU 31 then shifts the process to S11 again.

In the determination at S11, if it is determined that the user has not performed the operation of changing the disparity level by changing the position of the slider 79 (No at S11), the MPU 31 then determines if the operation mode is the manual picture position operation mode in which the manual operation mode radio button 91 is selected (S12).

In the determination at S12, if it is determined that the manual operation mode radio button 91 is not selected and the default mode radio button 92 is selected, the operation mode is not the manual picture position operation mode (No at S12). The process is shifted again to S11, and the subsequent process is performed in the same manner.

In the determination at S12, if it is determined that the manual operation mode radio button 91 is selected (Yes at S12), the operation mode is the manual picture position operation mode. The MPU 31 determines if the user has performed an operation of changing the picture position, by changing the position of the slider (image) 71 (S13).

In the determination at S13, if it is determined that the user has performed an operation of changing the picture position by changing the position of the slider (image) 71 (Yes at S13), the MPU 31 performs a picture position changing process (S18). In the picture position changing process, if the value specified in the picture position setting is larger than that before the changing operation, the MPU 31 controls to estimate the depth of the object with a picture position behind and further away from the object. If the value specified in the picture position setting is smaller than that before the changing operation, the MPU 31 controls to perform the object depth estimation with a picture position in front of the object and nearer to the viewer. The process is then shifted again to S11, and the subsequent process is performed in the same manner.

The picture position changing process will now be explained in detail.

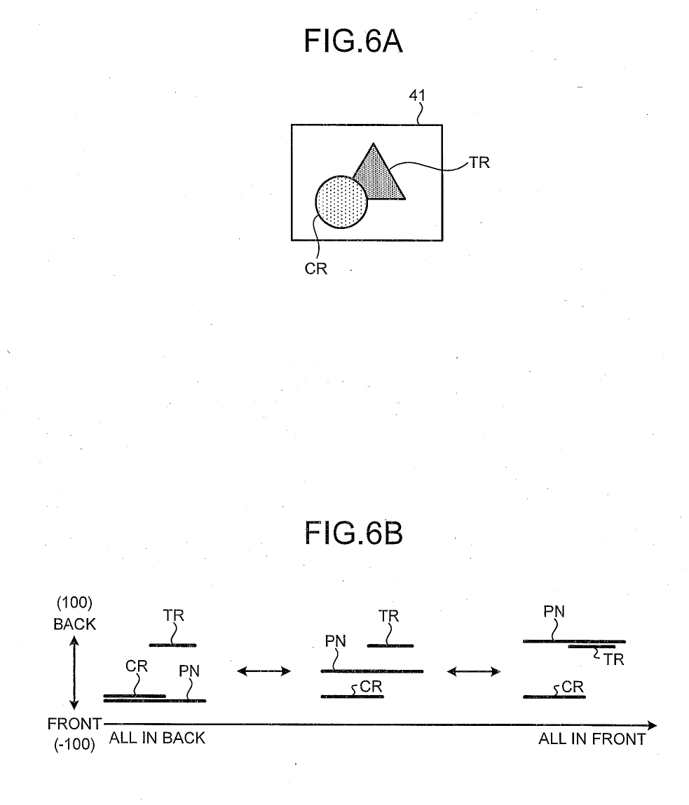

FIG. 6A is a first schematic view for explaining the picture position changing process.

Explained now as an example in which a circle CR and a triangle TR that are the objects are displayed in the three-dimensional image display area 41 of the display screen 40 on the display 23, as illustrated in FIG. 6A. In this example, the circle CR is in front of the triangle TR with respect to the viewpoint.

FIG. 6B is a second schematic view for explaining the picture position changing process.

Illustrated in FIG. 6B is a conceptual schematic of the circle CR and the triangle TR that are the objects looked down from above. When a smaller value is specified in the picture position setting, the depth estimation is performed to show a picture position PN nearer to the viewer than the circle CR and the triangle TR, as illustrated on the left side in FIG. 6B.

When specified is the median value in the settable range of the picture position setting, the depth estimation is performed to show the picture position PN behind the circle CR but in front of the triangle TR, in other words, the picture position PN positioned right at the middle between the circle CR and the triangle TR, as illustrated at the center in FIG. 6B.

When a larger value is specified in the picture position setting, the depth estimation is performed to show the picture position PN positioned behind the circle CR and the triangle TR, as illustrated on the right side in FIG. 6B.

In the determination at S13, if it is determined that the user has not performed the operation of changing the picture position by changing the position of the slider (image) 71 (No at S13), the MPU 31 determines if the user has performed an operation of changing the disparity sharpness by changing the position of the slider (image) 73 (S14).

In the determination at S14, if it is determined that the user has performed the operation of changing the disparity sharpness by changing the position of the slider (image) 73 (Yes at S14), the MPU 31 performs a disparity sharpness changing process (S19). In the disparity sharpness changing process, if the value specified in the disparity sharpness setting is larger than that before the changing operation, the MPU 31 controls to increase the sharpness at the border between the background and the object so that the border becomes sharper. If the specified value is smaller than that before the changing operation, the MPU 31 controls to reduce the sharpness at the border between the background and the object so that the border becomes more blurry. The process is then shifted again to S11, and the subsequent process is performed in the same manner.

The disparity sharpness changing process will now be explained in detail.

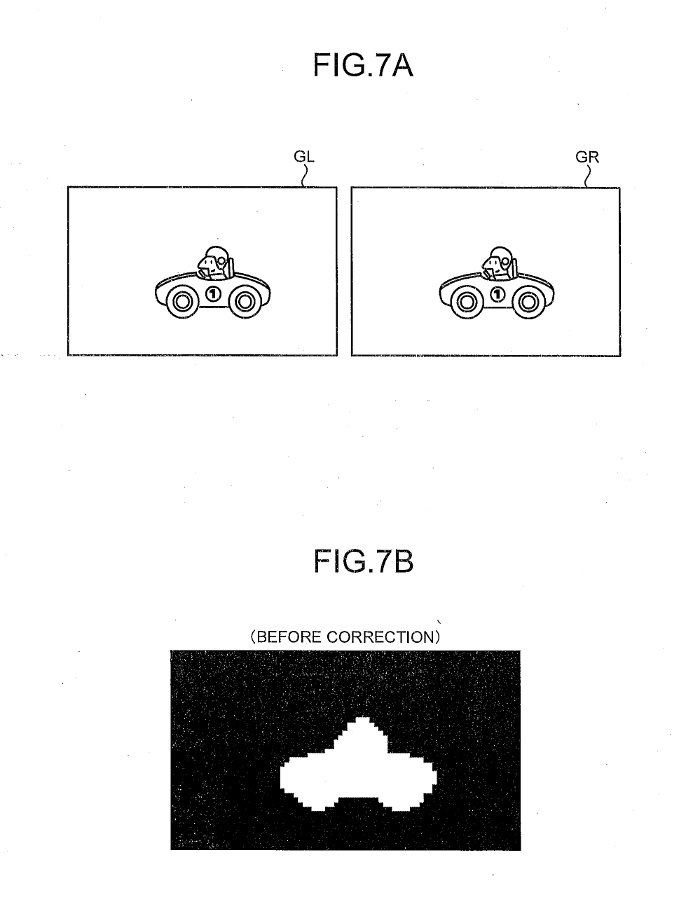

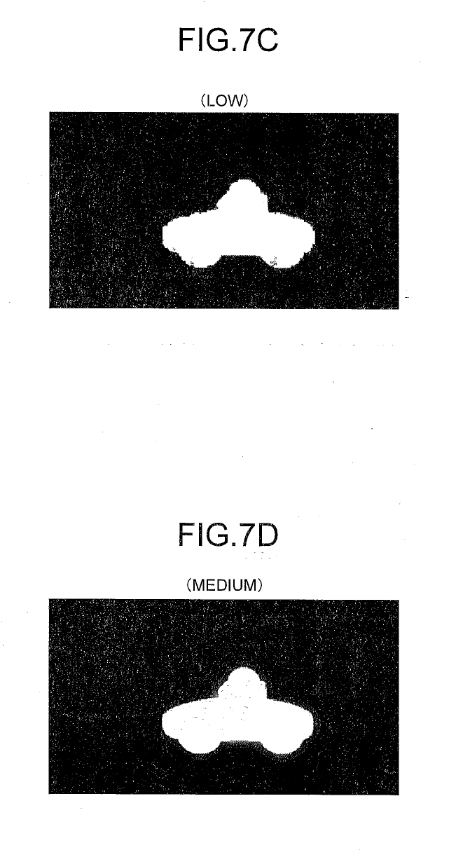

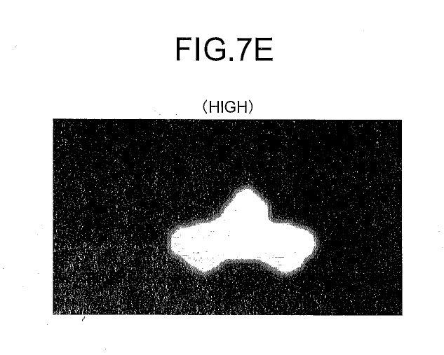

FIG. 7A is a schematic view for explaining an example of a parallax images in a stereo video.

FIG. 7B is a schematic view for explaining an example of extraction of an object position.

Binocular parallax images for generating a multiscopic image comprise a left eye image GL and a right eye image GR, as illustrated in FIG. 7A. With the left eye image GL and the right eye image GR, the position (depth) of an object (the racing car in the example of FIG. 7A) in the resultant multiscopic image is extracted as having a block-like shape with a bumpy perimeter, as illustrated in FIG. 7B.

If a multiscopic image is generated based on FIG. 7B, the resultant three-dimensional image would appear unnatural because the multiscopic image would have block-like noise around the object, despite the actual object does not have such a bumpy shape.

FIG. 7C is a schematic view for explaining the disparity sharpness changing process with a small amount of disparity sharpness adjustment, achieved by setting the disparity sharpness adjustment intensity to a low level.

As illustrated in FIG. 7C, with a small amount of the disparity sharpness adjustment (when the disparity sharpness adjustment intensity is set to a low level), the resultant image become more similar to that illustrated in FIG. 7B, and the disparity between the background and the object remains large. Therefore, the three-dimensional effect is emphasized. However, the block-like noise still remains around the object, although some improvement is made compared with the example illustrated in FIG. 7B, and the resultant three-dimensional image might not look natural.

FIG. 7D is a schematic view for explaining the disparity sharpness changing process with a medium amount of disparity sharpness adjustment, achieved by setting the disparity sharpness adjustment intensity to a medium level.

As illustrated in FIG. 7D, with a medium amount of disparity sharpness adjustment (when the disparity sharpness adjustment intensity is set to a medium level), the disparity between the background and the object is at a medium level. While the three-dimensional effect is somewhat reduced, because the block-like noise around the object is also reduced, the resultant three-dimensional image appears more natural.

FIG. 7E is a schematic view for explaining the disparity sharpness changing process with a large amount of disparity sharpness adjustment, achieved by setting the disparity sharpness adjustment intensity to a high level.

As illustrated in FIG. 7E, with a large amount of disparity sharpness adjustment (when the disparity sharpness adjustment intensity is set to a high level), because the disparity between the background and the object is further reduced, the three-dimensional effect is also reduced. The block-like noise around the object, however, can also be suppressed, so that the border between the background and the object looks more natural. Therefore, a more natural-looking three-dimensional image can be achieved.

In the determination at S14, if it is determined that the user has not performed the operation of changing the disparity sharpness by changing the position of the slider (image) 73 (No at S14), the MPU 31 determines if the user has performed an operation of adjusting the disparity stability by changing the position of the slider (image) 75 (S15).

In the determination at S15, if it is determined that the user has performed the operation of adjusting the disparity stability by changing the position of the slider (image) 75 (Yes at S15), the MPU 31 performs a disparity stability adjustment process (S20). In the disparity stability adjustment process, if the value specified in the disparity stability adjustment setting is larger than that before the changing operation, the MPU 31 controls to reduce the chronological variation of the depth-direction position of the object with respect to the background. If the value specified in the disparity stability adjustment setting is smaller than that before the changing operation, the MPU 31 controls not to reduce the chronological variation of the depth-position of the object with respect to the background. The process is then shifted again to S11, and the subsequent process is performed in the same manner.

The disparity stability adjustment process will now be explained in detail.

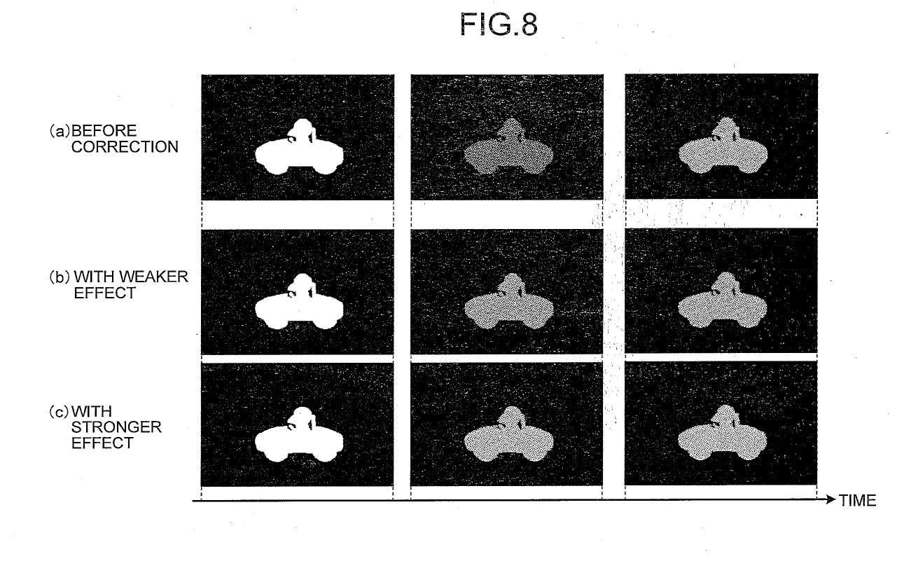

FIG. 8 is a schematic view for explaining the disparity stability adjustment process.

In FIG. 8, the MPU 31 recognizes that the object is moving across the same distance with respect to the video cameras 11-1 and 11-2, corresponding to the viewpoint, in the depth direction, and recognizes that the distance changes when the video cameras 11-1 and 11-2 vibrate, for example.

The section (a) in FIG. 8 illustrates the images before the disparity stability adjustment process. The area corresponding to the object extracted from the image is represented lighter when the MPU 31 recognizes that the object is positioned closer to (positioned at a shorter distance to) the viewpoint, and is represented darker when the MPU 31 recognizes that the object is positioned further away from (positioned at a longer distance from) the viewpoint.

If multiscopic images are generated using these images as they are, the distance to the object would be represented as changing, despite the distance is not changing, and the resultant three-dimensional images may appear awkward to viewers.

The section (b) in FIG. 8 corresponds to the disparity stability adjustment process with a small amount of disparity stability adjustment, achieved by setting the disparity stability adjustment intensity to a low level.

In the example illustrated in the section (b) in FIG. 8, while variations in the position with respect to the viewpoint are suppressed compared with the example illustrated in the section (a) in FIG. 8, some variations in the distance are still found in the image at the center and the image on the right side. As a result, three-dimensional images exhibiting more natural-looking movement can be achieved than in the example illustrated in the section (a) in FIG. 8, despite there are still some variations in the distance.

The section (c) in FIG. 8 corresponds to the disparity stability adjustment process with a large amount of disparity stability adjustment, achieved by setting the disparity stability adjustment intensity to a high level. Compared with the examples illustrated in the sections (a) and (b) in FIG. 8, variations in the positions with respect to the viewpoint are suppressed, and there is almost no variation in the distance. As a result, three-dimensional images exhibiting more natural-looking movement can be achieved than in the examples illustrated in the sections (a) and (b) in FIG. 8.

In the determination at S15, if it is determined that the user has not performed the operation of adjusting the disparity stability by changing the position of the slider (image) 75 (No at S15), the MPU 31 determines if the user has performed an operation of adjusting the disparity boundary by changing the position of the slider (image) 77 (S16).

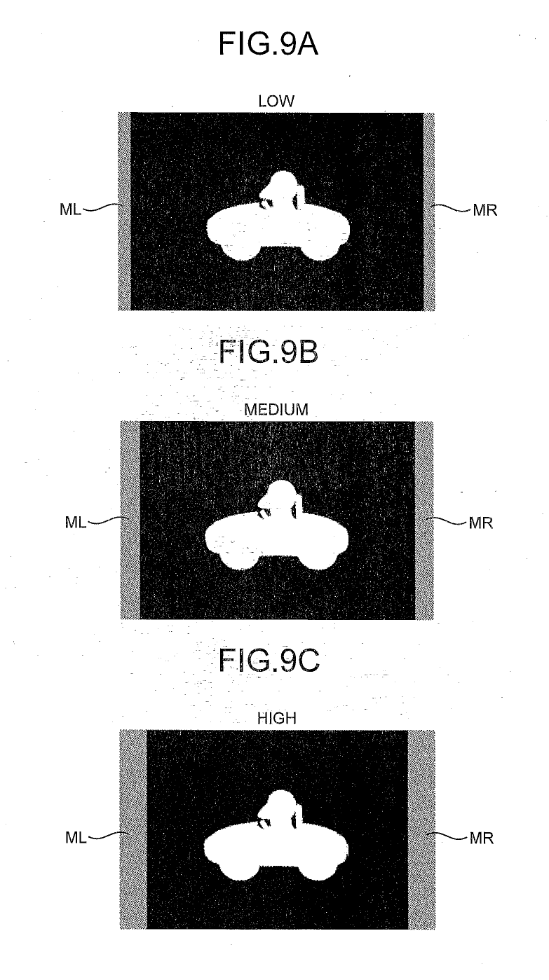

FIG. 9A is a schematic view for explaining the disparity boundary adjustment process with a small amount of disparity boundary adjustment, achieved by setting the disparity boundary adjustment intensity to a low level.

In the determination at S16, if it is determined that the user has performed the operation of adjusting the disparity boundary by changing the position of the slider (image) 77 (Yes at S16), the MPU 31 performs a disparity boundary adjustment process (S21). In the disparity boundary adjustment process, if the value specified in the disparity boundary adjustment setting is larger than that before the changing operation, the MPU 31 controls to increase the width (in the right-and-left direction) of band-like mask areas ML and MR that are positioned on the right and the left ends of the background portion of each of the left eye image GL and the right eye image GR, for example, in the example illustrated in FIG. 9A. Such band-like mask areas ML and MR are band-like uncommon areas (areas represented only in one of the images) in which the parallax is set to zero (in other words, corresponding to the picture position). If the value specified in the disparity boundary adjustment setting is smaller than that before the changing operation, the MPU 31 controls to decrease the width (in the right-and-left direction) of the band-like mask areas ML and MR that are the band-like uncommon areas (area presented only in one of the images) in which the parallax is set to zero (in other words, corresponding to the picture position). The process is then shifted again to S11, and the subsequent process is performed in the same manner.

The disparity boundary adjustment process will now be explained in detail.

As illustrated in FIG. 9A, with a small amount of disparity boundary adjustment (when the disparity boundary adjustment intensity is set to a low level), the width (in the right-and-left direction) of the band-like mask areas ML and MR that are the band-like uncommon areas (area presented only in one of the images) in which the parallax is set to zero (in other words, corresponding to the picture position) become reduced (narrower), so that the display area for the images with a parallax is increased. As a result, it becomes more likely that an image with a higher three-dimensional effect is presented, but the uncommon areas are more likely to appear near the band-like mask areas ML and MR, and spiraling noise may appear. Therefore, a three-dimensional image somewhat unnatural as a whole is likely to be presented.

FIG. 9B is a schematic view for explaining the disparity boundary adjustment process with a medium amount of disparity boundary adjustment, achieved by setting the disparity boundary adjustment intensity to a medium level.

With a medium amount of disparity boundary adjustment (when the disparity boundary adjustment intensity is set to a medium level), the width of the band-like mask areas ML and MR is set to the medium level, as illustrated in FIG. 9B, so that the display area for the images with a parallax is somewhat reduced, and no three-dimensional effect is achieved on the right and the left ends. It is however less likely for the uncommon areas to appear near the band-like mask areas ML and MR, and spiraling noise is suppressed. Therefore, a more natural three-dimensional image as a whole can be presented.

FIG. 9C is a schematic view for explaining the disparity boundary adjustment process with a large amount of disparity boundary adjustment, achieved by setting the disparity boundary adjustment intensity to a high level.

With a large amount of the disparity boundary adjustment (when the disparity boundary adjustment intensity is set to a high level), the display area for the images with a parallax is further reduced, as illustrated in FIG. 9C, the area with no three-dimensional effect is increased in the entire image, but it is lesser likely for the uncommon areas to appear near the band-like mask areas ML and MR, and the spiraling noise is further suppressed. Therefore, a more natural and less awkward three-dimensional image can be presented, despite the entire image appears flat.

In the determination at S16, if it is determined that the user has not performed the operation of changing the disparity boundary by changing the position of the slider (image) 77 (No at S16), the process is shifted again to S11, and the same process is repeated thereafter.

As described above, according to the embodiment, because not only the disparity level (stereoscopic intensity), but also the picture position, the disparity sharpness, the disparity stability, the disparity boundary, and the like can be adjusted, more natural-looking three-dimensional images can be presented based on user preferences, while ensuring the three-dimensional effect.

When an n-parallax image is converted into an m-parallax (m>n) image, in particular, as in an autostereoscopic display, by performing the depth estimation before conversion of the n-parallax image into the m-parallax image, and by generating the m-parallax image based on the depth estimation, it becomes possible to generate a multiscopic image from which a more natural-looking three-dimensional image desired by a user can be generated.

Explained in the description above is an example in which a multiscopic image is generated from binocular parallax images, but with the embodiment, a multiscopic image may be generated from three or more parallax images.

The computer program executed in the electronic device according to the embodiment is provided in a manner recorded in a computer-readable recording medium such as a compact disc read-only memory (CD-ROM), a flexible disk (FD), a compact disc recordable (CD-R), or a digital versatile disc (DVD), as a file in an installable or executable format.

The computer program executed in the electronic device according to the embodiment may be stored in a computer connected to a network such as the Internet, and made available for download over the network. The computer program executed in the electronic device according to the embodiment may also be provided or distributed over a network such as the Internet.

The computer program executed in the electronic device according to the embodiment may be provided in a manner incorporated in a ROM or the like in advance.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a hardware processor configured to:
output a user interface for designating disparity sharpness related to a difference in sharpness at a border between an object and a background of the object, the difference resulting from a difference in depth-direction distances of the object and the background;
set the sharpness at the border between the background and the object based on the disparity sharpness designated via the user interface; and
generate one multiscopic image from parallax images.

2. The electronic device according to claim 1, wherein
the user interface is configured to designate disparity stability related to intensity at which chronological variation of a depth-direction distance of the object is suppressed, and
the hardware processor is further configured to generate one multiscopic image using the parallax images by setting the depth-direction distance of the object based on the disparity stability designated via the user interface.

3. The electronic device according to claim 1, wherein
the user interface is configured to designate a size of a first area in which the depth-direction distances are handled as same, from a second area not common among the parallax images, and
the hardware processor is further configured to generate one multiscopic image using the parallax images by setting the first area, based on the size of the first area, the size being designated via the user interface.

4. The electronic device according to claim 1, wherein
the user interface is configured to designate which one of image positions in each of the parallax images is used as the picture position,
the hardware processor is further configured to perform picture position correction on each of the parallax images by setting the designated image position in each of the parallax images as the picture position, the image position being designated via the user interface, and
the user interface is configured to visually present the designated image position.

5. The electronic device according to claim 4, wherein the user interface is configured to set a recessing amount or a protruding amount of the image position other than the picture position.

6. A method executed on an electronic device, the method comprising:
outputting a user interface for designating disparity sharpness related to a difference in sharpness at a border between an object and a background of the object, the difference resulting from a difference in depth-direction distances of the object and the background; and
setting the sharpness at the border between the background and the object based on the disparity sharpness designated via the user interface, and generating one multiscopic image from parallax images.

7. The method according to claim 6, further comprising generating one multiscopic image using the parallax images by setting a depth-direction distance of the object based on a disparity stability designated via the user interface, wherein
the user interface is configured to designate the disparity stability related to intensity at which chronological variation of the depth-direction distance of the object is suppressed.

8. The method according to claim 6, further comprising generating one multiscopic image using the parallax images by setting a first area in which the depth-direction distances are handled as same, based on a size of the first area, the size being designated via the user interface, wherein
the user interface is configured to designate the size, from a second area not common among the parallax images.

9. The method according to claim 6, further comprising performing picture position correction on the parallax images by setting the designated image position in each of the parallax images as a picture position, the image position being designated via the user interface, wherein
the user interface is configured to designate which one of image positions in each of the parallax images is used as the picture position, and
the user interface is configured to visually present the designated image position.

10. The method according to claim 9, wherein the user interface is configured to set a recessing amount or a protruding amount of the image position other than the picture position.

11. A computer program product including programmed instructions, embodied in and stored on a non-transitory computer readable medium, wherein the instructions, when executed by a computer, cause the computer to perform:
outputting a user interface for designating disparity sharpness related to a difference in sharpness at a border between an object and a background of the object, the difference resulting from a difference in depth-direction distances of the object and the background; and
setting the sharpness at the border between the background and the object based on the disparity sharpness designated via the user interface, and generating one multiscopic image from parallax images.

12. The computer program product according to claim 11, wherein the instructions, when executed by the computer, further cause the computer to perform generating one multiscopic image using the parallax images by setting a depth-direction distance of the object based on a disparity stability designated via the user interface, wherein
the user interface is configured to designate the disparity stability related to intensity at which chronological variation of the depth-direction distance of the object is suppressed.

13. The computer program product according to claim 11, wherein the instructions, when executed by the computer, further cause the computer to perform generating one multiscopic image using the parallax images by setting a first area in which the depth-direction distances are handled as same, based on a size of the first area, the size being designated via the user interface, wherein
the user interface is configured to designate the size of the first area, from a second area not common among the parallax images.

14. The computer program product according to claim 11, wherein the instructions, when executed by the computer, further cause the computer to perform picture position correction on the parallax images by setting a designated image position in each of the parallax images as a picture position, the image position being designated via the user interface, wherein
the user interface is configured to designate which one of image positions in each of the parallax images is used as the picture position, and
the user interface is configured to visually present the designated image position.

15. The computer program product according to claim 11, wherein the user interface is configured to set a recessing amount or a protruding amount of the image position other than the picture position.
